(19) United States
(12) Patent Application Publication
(10) Pub. No.: US 2020/0208829 A1
(43) Pub. Date: Jul. 2, 2020

(54) LED LAMP PLATE STRUCTURE

(71) Applicant: Youngju LEE, Anyang-Si, Gyeonggi-do (KR)

(72) Inventor: Youngju LEE, Anyang-Si, Gyeonggi-do (KR)

(21) Appl. No.: 15/752,440

(22) PCT Filed: Sep. 2, 2016
(86) PCT No.: PCT/KR2016/009874

§ 371 Date: Feb. 13, 2018

(30) Foreign Application Priority Data
Aug. 29, 2016 (KR) 10-2016-0110026

(51) Int. Cl. F21V 29/70; F21S 8/08; F21V 17/12; F21V 23/00

(52) U.S. Cl. CPC F21V 29/70; F21S 8/086; F21W 2131/103; F21V 23/001; F21V 17/12

(57) ABSTRACT

Disclosed is an LED lamp plate structure. The LED lamp plate structure includes an LED module composed of at least one LED element; and a heat dissipation plate having a surface area capable of allowing the heat dissipation plate to be engaged with at least a portion of a lamp housing of a street light, with the LED module being coupled on one surface of the heat dissipation plate so that the LED module faces an open surface of the lamp housing.

### BACKGROUND OF THE INVENTION

### Field of the Invention

The present invention generally relates to an LED lamp plate structure. More particularly, the present invention relates to an LED lamp plate structure applied to street lights.

### Description of the Related Art

Street lights refer to lamps disposed along streets for lighting of the streets, traffic safety, or fine decorative appearances and various light sources are applied thereto, such as a high pressure mercury-vapor lamp, a sodium-vapor lamp, a fluorescent lamp, and a general electric bulb.

FIG. 1 is a diagram showing components disposed in a lamp housing of a street light using general light source (e.g. high pressure mercury-vapor lamp).

As shown in FIG. 1, a street light provided with a general lamp such as high pressure mercury-vapor lamp includes a lamp housing 1 provided at an upper end of the street light and in which a lower surface thereof is opened, a lamp 101 and a ballast stabilizer 102 mounted inside the lamp housing 1, and a transparent cover 103 and a lower cover 104 finishing a lower surface of the lamp housing 1.

A high pressure mercury-vapor lamp and sodium-vapor lamp have been mostly used for light sources of street lights. A high pressure mercury-vapor lamp has excellent characteristics such as high brightness, low power consumption compared to incandescent lamps, and high efficiency. However, the high pressure mercury-vapor lamp takes long time to be stabilized after lighting and takes time to be relit.

On the other hand, an LED lamp has excellent characteristics such as long life span and low energy consumption, and is environmental friendly compared with conventional light sources for street lights since the LED lamp contains no hazardous material such as mercury or lead.

Street lights using conventional lamps need a lot of components, but LED lamps having excellent characteristics compared with existing light sources for street lights need fewer components.

Therefore, there are demands for replacing conventional lamps with LED lamps in street lights.

### SUMMARY OF THE INVENTION

Accordingly, the present invention has been made keeping in mind the above problems occurring in the related art, and the present invention is intended to propose an LED lamp plate structure configured to realize a heat dissipating function to replace existing lamps of street lights with LED lamps including the LED lamp plate structure while keeping the existing street light lamp housing.

In order to achieve the above object, according to one aspect of the present invention, there is provided an LED lamp plate structure, the structure including: an LED module composed of at least one LED element; and a heat dissipation plate having a surface area capable of allowing the heat dissipation plate to be engaged with at least a portion of a lamp housing of a street light, with the LED module being coupled on one surface of the heat dissipation plate so that the LED module faces an open surface of the lamp housing.

According to an embodiment of the present invention, an LED lamp plate structure configured to realize a heat dissipating function that allows existing lamp of street light to be easily replaced with an LED lamp including the LED lamp plate structure while keeping the existing street light lamp housing.

### BRIEF DESCRIPTION OF THE DRAWINGS

The above and other objects, features and other advantages of the present invention will be more clearly understood from the following detailed description when taken in conjunction with the accompanying drawings. Reference now should be made to the drawings, in which the same reference numerals are used throughout the different drawings to designate the same or similar components. The present invention may, however, be embodied in many different forms and should not be construed as being limited to only the embodiments set forth herein, but should be construed as covering modifications, equivalents or alternatives falling within ideas and technical scopes of the present invention.

FIG. 1 is an exploded perspective view showing components disposed in a lamp housing of a conventional street light using a general light source;

FIG. 2 is an exploded perspective view showing an LED lamp plate structure according to the related art, provided with conventional heat dissipation plates;

FIG. 3 is an exploded perspective view showing an LED lamp plate structure coupled to a lamp housing according to an embodiment of the present invention;

FIG. 4 is an exploded perspective view showing an LED module coupled to a heat dissipation plate according to an embodiment of the present invention;

FIGS. 5A and 5B are views showing heat dissipation plates according to different embodiments of the present invention, each provided with a plurality of depressions thereon;

FIGS. 6A and 6B are views showing heat dissipation plates according to different embodiments of the present invention, each processed to enlarge a surface area thereof;

FIG. 7 is an exploded perspective view showing an LED lamp plate structure including a heat dissipation plate, an LED module, and a transparent cover according to an embodiment of the present invention;

FIG. 8 is an exploded perspective view showing an LED lamp plate structure including a heat dissipation plate, an LED module, a transparent cover, and a rubber packing according to an embodiment of the present invention;

FIG. 9 is a view showing a lock device coupling a heat dissipation plate to a lamp housing according to an embodiment of the present invention;

FIGS. 10A and 10B are views showing a heat dissipation plate-engaging means including a vertical slide block and a lateral slide block according to an embodiment of the present invention;

FIG. 11 is an exploded perspective view showing an LED lamp plate structure including a threaded hole communicating with a threaded hole of a lamp housing, and a through hole through which an electric wire passes, according to an embodiment of the present invention;

FIG. 12 is an exploded perspective view showing a heat dissipation plate and a plate guard according to an embodiment of the present invention;

FIGS. 13A and 13B are sectional views showing the plate guard and a screw guard according to the embodiment of FIG. 12;

FIG. 14 is an exploded perspective view showing a heat dissipation plate and a plate guard according to another embodiment of the present invention; and

FIGS. 15A and 15B are sectional views showing the plate guard and a screw guard according to the embodiment of FIG. 14.

### DETAILED DESCRIPTION OF THE INVENTION

Hereinbelow, exemplary embodiments of the present invention will be described in detail with reference to the accompanying drawings. In the following description, numerous specific details are set forth. However, it is understood that embodiments of the invention may be practiced without these specific details. Reference will now be made in detail to various embodiments of the present invention, specific examples of which are illustrated in the accompanying drawings and described below, since the embodiments of the present invention can be variously modified in many different forms. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims.

Also, various aspects and features will be presented by systems that can include a multiplicity of devices, components and/or modules, etc. In this regard, it should be understood and acknowledged that a variety of systems can comprise additional devices, components and/or modules, and/or they also may not comprise all of the devices, components, modules, etc. discussed with respect to the drawings.

In addition, the term “or” is intended to refer to “or” in a comprehensive manner, not “or” in an exclusive manner. That is, unless specified otherwise or correct in the context, “X uses A or B” is intended to mean one of natural comprehensive substitutions. That is, where the cases that “X uses A”, “X uses B”, and “X uses A and B” are all used, “X uses A or B” is applicable to any of the above-described cases. Also, it should also be understood to cover that the term “and/or” used in the specification for the subject application refers to all of the possible combinations of more than one items among the related items enumerated therein.

The terms “comprise” and/or “comprising” means inclusion of a shape, number, process, operations, member, element, and/or a group of those, but do not mean exclusion of or denial of addition of another shape, number, process, operation, element, and/or a group of those. The singular forms “a”, “an”, and “the” are intended to include the plural forms as well, unless the context clearly indicates otherwise.

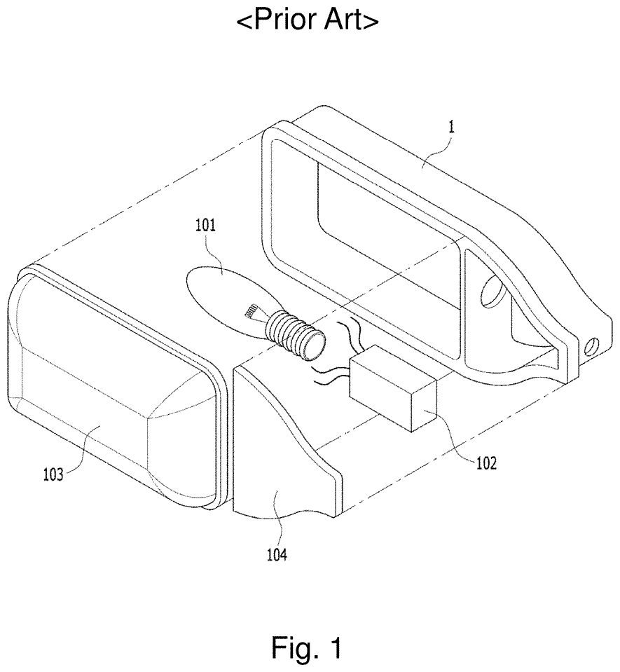

FIG. 1 is an exploded perspective view showing components disposed in a lamp housing of a conventional street light using a general light source.

Conventional installed street lights may be provided with a light source such as high pressure mercury-vapor lamp, sodium-vapor lamp, fluorescent lamp, general electric bulb.

As describe above, the high pressure mercury-vapor lamp has excellent characteristics such as high brightness, low power consumption compared to incandescent lamps, and high efficiency. However, the high pressure mercury-vapor lamp takes long time to be stabilized after lighting and takes time to be relit.

A conventional street light may include a lamp 101, a ballast stabilizer 102, a lamp housing 1 receiving the lamp 101, a transparent cover 103 protecting the lamp, and a lower cover 104 protecting electronic components such as the ballast stabilizer. In addition, the conventional street light may further include various sensors and controllers.

On the other hand, an LED lamp has less weight and smaller volume than other light source lamps. In addition, the LED lamp has excellent characteristics such as long life span and low energy consumption, and is environmental friendly compared with conventional light sources for street lights since the LED lamp contains no hazardous material such as mercury or lead.

Street lights using conventional lamps need a lot of components, but LED lamps having excellent characteristics compared with conventional light sources for street lights need fewer components.

The LED lamp consumes less power and has longer life span than the conventional lamp. For example, a 250 W metal halide light source typically has a life span of 8,000 hours, while a 100 W LED light source has a life span of 50,000 hours. Meanwhile, the LED lamp is an electronic component consuming current, so there is a heat generation phenomenon and attention should be paid to heat dissipation.

Although there have been attempts to replace street lights with LED lamps in the past, products with heat dissipation plates attached to the LED lamps have been difficult to be used for replacement of conventional lamps due to heavy weight such LED lamps.

Hereinafter, an LED lamp plate structure that is capable of being installed in conventional street lights will be described below.

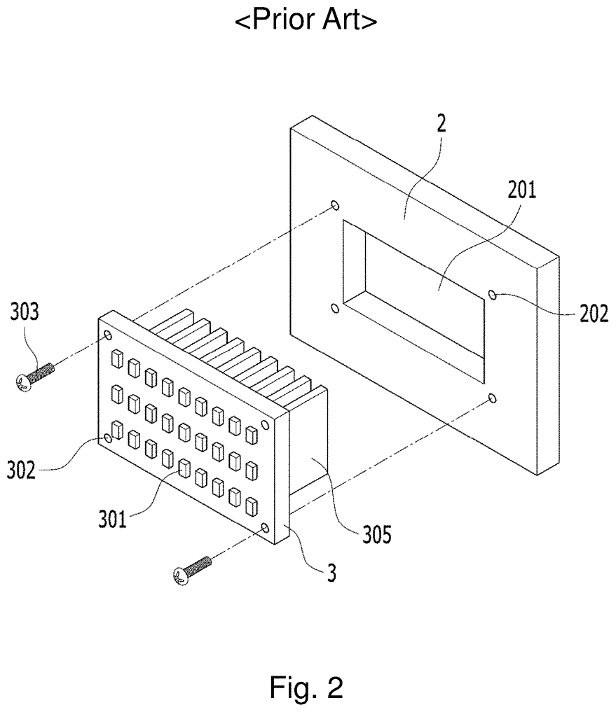

FIG. 2 is an exploded perspective view showing an LED lamp plate structure according to the related art, provided with conventional heat dissipation plates 305.

The LED lamp plate structure may include an LED module 3 composed of one or more LED elements 301, a plate 2 for supporting the LED module 3, and heat dissipation plates 305 dissipating heat generated from the LED module.

The heat dissipation plates 305 are attached to a back surface of the LED module 3 and come into contact with the LED element 301. In addition, the heat dissipation plates 305 are made of a metal having a fine thermal conductivity. Since a larger surface area leads to a larger heat dissipation effect, the heat dissipation plates 305 occupy a large volume beside an attached surface thereof. The plate 2 may include an opening 201 in which the heat dissipation plates 305 pass therethrough to combine the LED module 3 provided with the heat dissipation plates 305 to the plate 2. As described above, when the heat dissipation plates 305 are disposed between the LED element 301 and the plate 2 and the opening 201 exists, the LED element 301 and the plate 2 are impossible to directly come into contact with each other.

The conventional LED lamp plate structure may further include screw holes 202 and 302 and a screw 303 to combine the heat dissipation plate 2 and the LED module 3. Street lights require robustness and durability because installation and replacement thereof are difficult to be conducted often. It is preferable that each diameter of the screw 303 and the screw holes 202 and 302 has in a range of 3 mm to 6 mm, but the screw 303 and the screw holes 202 and 302 which are smaller or larger than the range may be used.

The conventional LED lamp plate structure may weigh 15 kg or more depending on a material, including weights of the heat dissipation plates 305. In addition, the heat dissipation plates 305 are configured as a shape to enlarge a surface area thereof, and thus have a large volume. Therefore, there are conventional LED lamp plate structures having a thickness of 90 mm or more. It is difficult to replace the street lights lamps with a bulky and heavy LED lamp plate structure at over 8 m height where street lights are normally installed. This is because it is not only inconvenient to replace street lamps, but also increases the risk of a worker falling due to heavy LED lamp, which is held by a worker for a long time.

Hereinbelow, an LED lamp plate structure configured to realize a heat dissipating function without having conventional heat dissipation plates 305 according to an embodiment of the present invention will be described in detail.

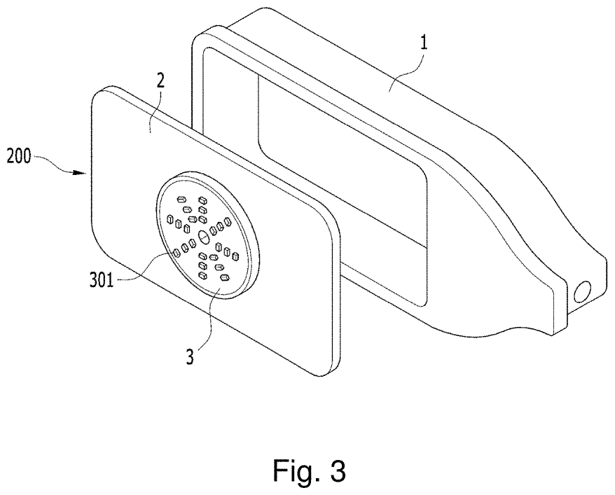

FIG. 3 is an exploded perspective view showing an LED lamp plate structure 200 coupled to a lamp housing 1 according to an embodiment of the present invention.

The LED lamp plate structure 200 according to the embodiment of the present invention includes an LED module 3 composed of at least one LED element 301 and a heat dissipation plate 2.

The LED module 3 according to the embodiment of the present invention is configured as a plate shape and the LED elements 301 are disposed at one surface of the LED module 3. The LED module 3 may be configured as various shapes of polygons such as circle, quadrangle, etc. The LED module 3 may be configured to be corresponding to a shape of an inner circumferential surface of the lamp housing 1. However, for example, the LED module 3 may be configured as a circle even though the inner circumferential surface of the lamp housing 1 is a quadrangle, as shown in FIG. 3.

Components consuming various amounts of power may be used as the LED elements 301 according to the embodiment of the present invention depending on purposes and locations where the street lights are installed. LED elements 301, which typically consume 40 W to 150 W of power, may be used. The LED elements 301 may be arranged in a lattice pattern of matching rows and columns, and may be arranged in the form of a plurality of concentric circles in some cases.

The heat dissipation plate 2 according to the embodiment of the present invention has a surface area capable of allowing the heat dissipation plate 2 to be engaged with at least a portion of the lamp housing 1 of the street light, with the LED module 3 being coupled on one surface of the heat dissipation plate 2 so that the LED module 3 faces an open surface of the lamp housing 1. The heat dissipation plate 2 may have an outer circumferential surface at least partially adhered to the inner circumferential surface of the lamp housing 1 of the street light. Since the heat dissipation plate 2 according to the embodiment of the present invention is used to replace existing lamp of street lights, the heat dissipation plate 2 may have various sizes and shapes depending on the lamp housing 1 already installed.

The heat dissipation plate 2 according to the embodiment of the present invention may include a heat dissipation function, in addition to a function of supporting the LED module 3. The heat dissipation plate 2 of the present invention may be composed of metals having excellent thermal conductivities. As one example, the heat dissipation plate 2 may include aluminum or copper. In addition, the heat dissipation plate 2 according to the embodiment of the present invention may include one or more grooves at any one outer surface of the heat dissipation plate 2. Preferably, the heat dissipation plate 2 according to the embodiment of the present invention may include a perforation at the center of the heat dissipation plate 2. The heat dissipation plate 2 has an increased contact surface with air due to the perforation, thereby improving heat dissipation performance.

The LED lamp plate structure 200 of the present invention obtains the heat dissipation function without the conventional heavy heat dissipation plates 305 used conventionally as shown in FIG. 2. The LED lamp plate structure 200 according to the embodiment of the present invention is configured without the conventional heat dissipation plates 305 unlike the conventional LED lamp plate structure, and may be configured without the opening 201. Therefore, the heat dissipation plate comes into contact with the LED elements 301 directly. According to circumstances, a material having fine thermal conductivity such as thermal grease may be provided between the heat dissipation plate 2 and the LED elements 301.

After the LED lamp plate structure 200 is installed according to the embodiment of the present invention, a temperature is measured in a range of 27° C. to 41° C. The temperature range is an allowable range to safely operate the LED elements 301 consuming power in a range of 40 W to 150 W, so the LED lamp is capable of operating ordinarily without the conventional heat dissipation plates 305.

In addition, the present invention may have a weight in a range of 1 kg to 2 kg due to the simplification of the components and light weight characteristic of aluminum, which is the material of the heat dissipation plate 2. Also, since there is no conventional heat dissipation plates 305 in the present invention, the thickness of the heat dissipation plate 2 may be reduced to 5 mm or less. By minimizing the volume and the weight, the replacement is performed safely and easily. According to an embodiment of the present invention, the LED lamp plate structure 200 is replaced within a relatively short time of about 10 minutes. Furthermore, copper may be used as the material of the heat dissipation plate 2.

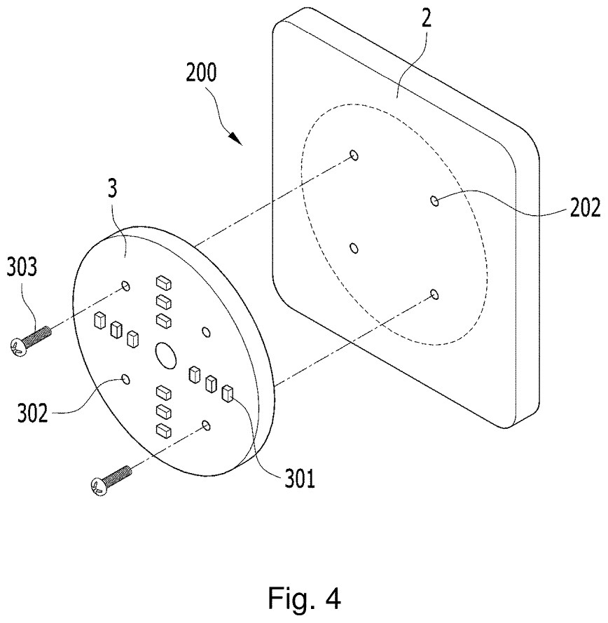

FIG. 4 is an exploded perspective view showing the LED module 3 coupled to the heat dissipation plate 2 according to the embodiment of the present invention.

As shown in figure, the LED module 3 may be provided with a screw hole 302 and the heat dissipation plate 2 may be provided with a screw hole 202 communicating with the screw hole 302 of the LED module, so the LED module 3 and the heat dissipation plate 2 are coupled to each other by a screw 303.

The coupling by the screw is only one example of the present invention. The present invention may include various coupling means coupling the heat dissipation plate 2 and the LED module 3 each other.

In another embodiment, depressions may be formed on the heat dissipation plate 2 in a form of a circumference, and protrusion portions may be formed on a rear surface of the LED module 3 so as to engage with the depressions, so that the LED module 3 may be rotated to come in close contact with the heat dissipation plate 2.

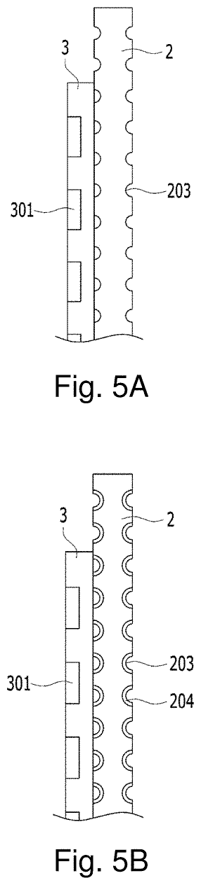

FIGS. 5A and 5B are views showing heat dissipation plates 2 according to different embodiments of the present invention, each provided with a plurality of depressions 203 thereon.

As described above, the present invention has a structure in which the LED module 3 and the heat dissipation plate 2 come into close contact to each other. According to the embodiment of the present invention, the heat dissipation plate 2 may be provided with the plurality of depressions 203 on at least one surface thereof to transfer heat easily. The plurality of depressions 203 are configured as fine grooves which are not observable without equipment such as magnifying glass. For example, the plurality of depressions 203 may be processed in units of μm.

In FIG. 5A, the heat dissipation plate 2 is provided with the plurality of depressions 203 on both surfaces thereof, but may be provided with the plurality of depressions 203 on any one surface of the heat dissipation plate 2. A surface area of the heat dissipation plate 2 is increased due to the plurality of depressions 203.

In addition, FIG. 5B shows the heat dissipation plate 2 further including a heat conductive portion 204 at a position where the plurality of depressions 203 is configured. The heat conductive portion 204 is treated to have an increased density dependent thermal conductivity characteristic, compared with an inside of the heat dissipation plate 2.

Generally, the higher the density, the smaller the pore size, so the thermal conductivity is lowered. However, when the density exceeds a specific density, the area of the material becomes larger than the area of the pores, so the thermal conductivity becomes higher. A high density dependent thermal conductivity characteristic means that the density exceeds the specific density, so the thermal conductivity is increased.

The heat conductive portion 204 is provided on a surface of the plurality of depressions 203 and density dependent thermal conductivity characteristic thereof is higher than the inside of the heat dissipation plate 2. The heat conductive portion 204 functions as transferring heat generated from the LED elements 301 to the plurality of depressions 203 of the heat dissipation plate 2 efficiently. The plurality of depressions 203 is exposed to air and a surface area thereof is large, so heat dissipation performance is improved. In addition, the plurality of depressions 203 has high density dependent thermal conductivity characteristic, so heat is dissipated efficiently.

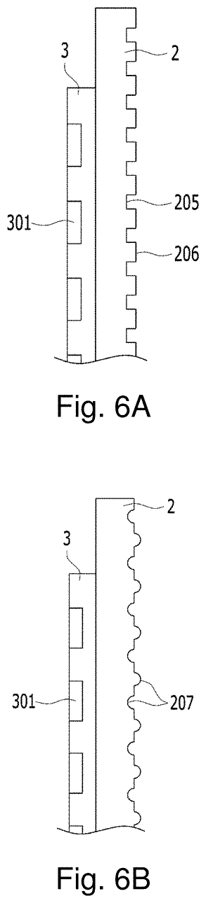

FIGS. 6A and 6B are views showing the heat dissipation plates 2 according to different embodiments of the present invention, each processed to enlarge a surface area thereof.

As the surface area of the heat dissipation plate 2 is larger, the contact area of the heat dissipation plate 2 with air becomes wider. Heat transfers from high temperature to low temperature, and air to which the heat dissipation plate 2 is exposed is atmospheric and a temperature of the air is constant. Therefore, the heat generated from the LED elements 301 is transferred to the air through the heat dissipation plate 2, and as the surface area of the heat dissipation plate 2 is wider, the heat dissipation effect becomes greater.

FIGS. 6A and 6B are only one embodiment that can increase the surface area, and the present invention may include other methods widening the surface area in addition to the shown process.

As shown in FIG. 6A, the heat dissipation plate 2 may be provided on at least one surface thereof with at least one depression 205 having a depressed cross section or at least one embossment 206 having an embossed cross section to enlarge the surface area.

The depression 205 and the embossment 206 may be configured as a concave or convex cross section of the heat dissipation plate 2 in a longitudinal or transverse direction, or in a lattice pattern. The depression 205 and the embossment 206 may be configured as a form of a concentric circle composed of a plurality of coincident centers when the heat dissipation plate 2 has a circular shape. In addition, it is not necessary that the depression 205 and the embossment 206 are configured in an intersection, and only the depression 205 or the embossment 206 may be formed repeatedly.

In addition, the cross section of the heat dissipation plate 2 according to the embodiment of the present invention may be provided with at least one depression or perforation. Therefore, the heat dissipation plate 2 has an increased contact surface with air, thereby improving heat dissipation performance.

As shown in FIG. 6B, the heat dissipation plate 2 may be processed on at least one surface thereof with embossments and depressions 207 to enlarge the surface area.

An embossing process is a process in which a plate or roll engraved on a single object or complex is strongly pressed to engrave embossments and depressions 207 or characters. For example, a single object or complex is pressed by passing between a sculpted iron roll and a cotton roll, or by passing between a couple of rolls engraved with concave-convex shapes. According to the embodiment of the present invention, the embossments and depressions 207 may be processed on one or both surfaces of the heat dissipation plate 2 and may be processed only on a portion of one surface, rather than on an entire area of one surface.

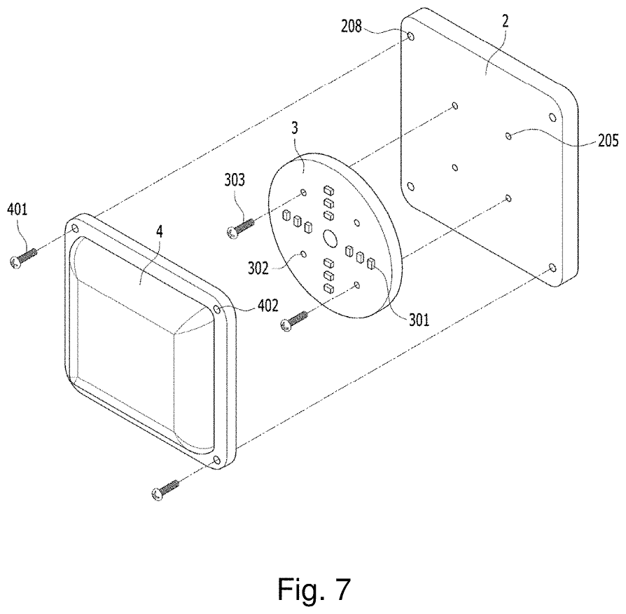

FIG. 7 is an exploded perspective view showing the LED lamp plate structure 200 including the heat dissipation plate 2, the LED module 3, and the transparent cover 4 according to the embodiment of the present invention.

The transparent cover 4 is combined with at least a portion of the heat dissipation plate 2 to cover the LED module 3 received in an inner space defined by the combination. The transparent cover 4 protects the LED module 3 from atmospheric phenomena such as rain, snow, wind, and bugs such as moths, mosquitoes, etc.

The transparent cover 4 may be provided with a screw hole 402, and the heat dissipation plate 2 may be provided with a screw hole 208 communicating with the screw hole 402 of the transparent cover 4. According to the embodiment of the present invention, the transparent cover 4 and the heat dissipation plate 2 are fastened together by using the screw 401, but may be coupled by other coupling means.

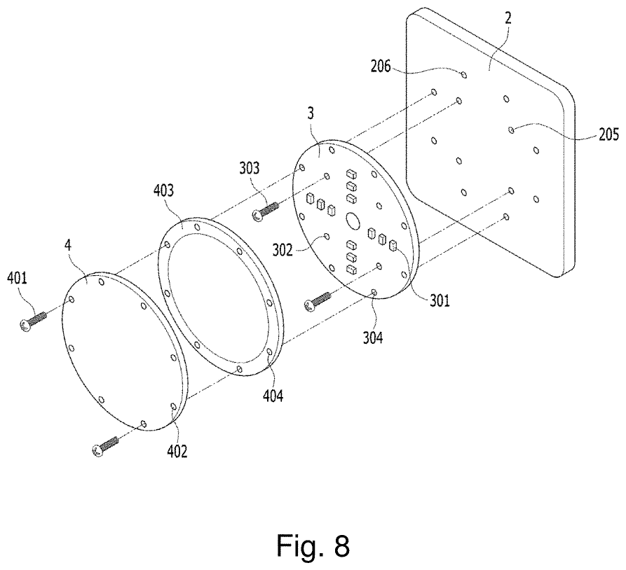

FIG. 8 is an exploded perspective view showing the LED lamp plate structure 200 including the heat dissipation plate 2, the LED module 3, the transparent cover 4, and a rubber packing 403 according to an embodiment of the present invention.

Meanwhile, the transparent cover 4 may be configured to not cover the LED module 3. When the transparent cover 4 is configured as a plate shape having a height which is impossible to receive the LED module 3 therein, the LED module 3 is protected by the rubber packing 403.

As shown in FIG. 8, the rubber packing 403 may be provided with a screw hole 404 communicating with the screw hole 402 of the transparent cover 4. In addition, the LED module 3 may be provided with a screw hole 304 communicating with the screw holes 402 and 404, and the heat dissipation plate 2 may be provided with the screw hole 208 communicating with the screw holes 402, 404, and 304. The transparent cover 4, the rubber packing 403, the LED module 3, and the heat dissipation plate 2 are fastened together by using the screw 401.

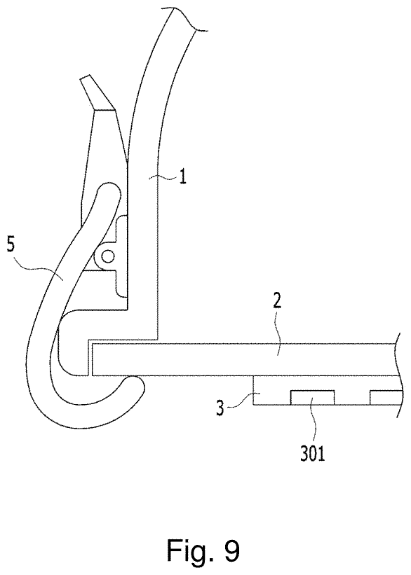

FIG. 9 is a view showing a lock device 5 coupling the heat dissipation plate 2 to the lamp housing 1 according to the embodiment of the present invention.

FIG. 9 shows a hook clamp mainly used to lock two separate members. The hook clamp refers to a device in which a ring part and a handle are connected to each other, engaging the ring to a part to be fixed, and then fixing the ring by applying pressure to the handle. FIG. 9 is only one embodiment of the present invention showing the lock device 5, and the lock device 5 may include other components which are needed to engage the lamp housing 1 and the heat dissipation plate 2. The lock device 5 may include a clamp tightened with a screw, a clip, a screw and a screw hole, etc, in addition to the hook clamp shown in FIG. 9.

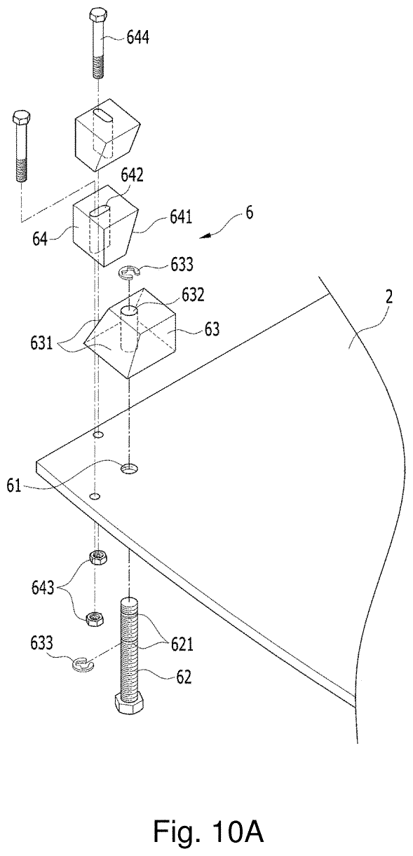

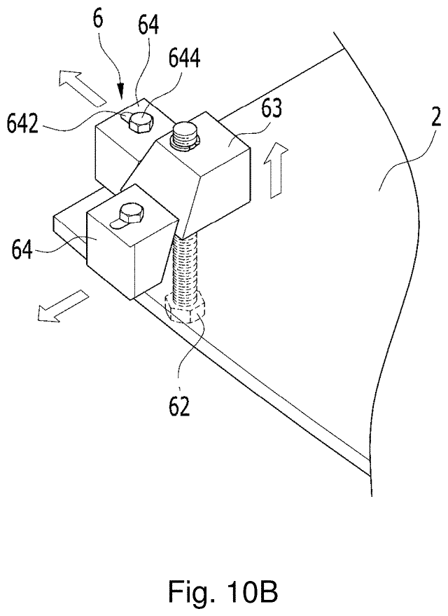

FIGS. 10A and 10B are views showing a heat dissipation plate-engaging means 6 including a vertical slide block 63 and a lateral slide block 64 according to the embodiment of the present invention.

The heat dissipation plate-engaging means 6 includes at least one vertical slide block 63 and at least lateral slide block 64 provided on at least a portion of an upper surface of the heat dissipation plate 2.

Lower and upper surfaces of the at least one vertical slide block 63 are configured as flat surfaces, and at least one side surface thereof is configured as an upward sloped surface sloped at a predetermined degree angle.

Lower and upper surfaces of the at least one lateral slide block 64 are configured as flat surfaces, and at least one side surface thereof is configured as a downward sloped surface sloped at a predetermined degree angle to be brought into close contact with the upward sloped surface.

Meanwhile, the heat dissipation plate 2 is provided with a screw hole 61 penetrated vertically and provided with screw threads on an inner circumferential surface thereof. The vertical slide block 63 may include an adjustment screw 62 engaged to the screw hole 61 by being inserted into the screw hole 61 from bottom, and provided with an annular groove 621 on which a snap ring 633 is mounted.

According to the embodiment of the present invention, two side surfaces of the vertical slide block 63, which face the wall surface of the lamp housing 1, may be configured as upward sloped surfaces 631 facing upward. In addition, the vertical slide block 63 is provided with a through hole 632, and the adjustment screw 62 passing through the through hole 632 may be provided with the annular groove 621 on which the snap ring 633 is mounted. When the adjustment screw 62 is rotated, the vertical slide block 63 may rotate with respect to the adjustment screw 62, but may be fixed not to move up and down due to the snap ring 633.

According to the embodiment of the present invention, one side surface of the lateral slide block 64 may be configured as a downward sloped surface 641, which is in close contact with one of the two upward sloped surfaces 631. In addition, the lateral slide block 64 may be provided with an elongated hole 642 penetrating therethrough vertically and extending in a direction of the downward sloped surface 641. The lateral slide block 64 may operate as a pair, and may be provided with a guide bolt 644 that passes through the elongated hole 642 and the heat dissipation plate 2 and is then fastened by using a fixing nut 643.

As shown in FIGS. 10A and 10B, when the vertical slide block 63 rises, two lateral slide blocks 64 are pressed against an inner side surface of the lamp housing 1 such that normal forces between the lamp housing 1 and the lateral slide blocks 64 are increased. Accordingly, as static frictional forces between the lamp housing 1 and the lateral slide blocks 64 increase, the heat dissipation plate 2 coupled to the lateral slide blocks is more firmly engaged to the lamp housing 1.

Since replacing the lamps of the street lights is performed at a high place, a worker is stressful due to a limited work space, so that it is difficult to work precisely.

Therefore, even in the work of firmly engaging the heat dissipation plate 2 to the lamp housing 1, it may be difficult to do work such as turning the screw after aligning it with the screw hole.

Therefore, according to the embodiment of the present invention shown in FIGS. 10A and 10b, an additional heat dissipation plate-engaging means 6 is provided so that the lateral slide block 64 does not deviate from the edge of the heat dissipation plate 2, the heat dissipation plate 2 is placed in the lamp housing 1, and the adjustment screw 62 is adjusted to engage the heat dissipation plate 2 to the lamp housing 1 more firmly.

That is, when the worker rotates the adjustment screw 62, the vertical slide block 63 is raised and the lateral slide block 64 having the downward sloped surface 641 closely coming into contact with the upward sloped surface 631 is pushed to the inner side surface of the housing 1 and tightly engaged thereto.

In addition, the vertical slide block 63 and the lateral slide block 64 shown in FIGS. 10A to 10B are merely illustrative, and may be configured as any structure in which the vertical movement of the vertical slide block 63 is converted to the lateral movement of the lateral slide block 64.

The heat dissipation plate-engaging means 6 is not necessarily configured as a block structure, and may be configured as a lateral gear (not shown) of the upper or lower surface of the heat dissipation plate 2 converting a vertical movement of an attached bolt (not shown) inserted from the lower surface of the heat dissipation plate 2 to a lateral direction.

The described embodiment is one embodiment of the heat dissipation plate-engaging means 6. Any heat dissipation plate-engaging means 6 capable of increasing the static frictional force between the heat dissipation plate 2 and the lamp housing 1 may be employed.

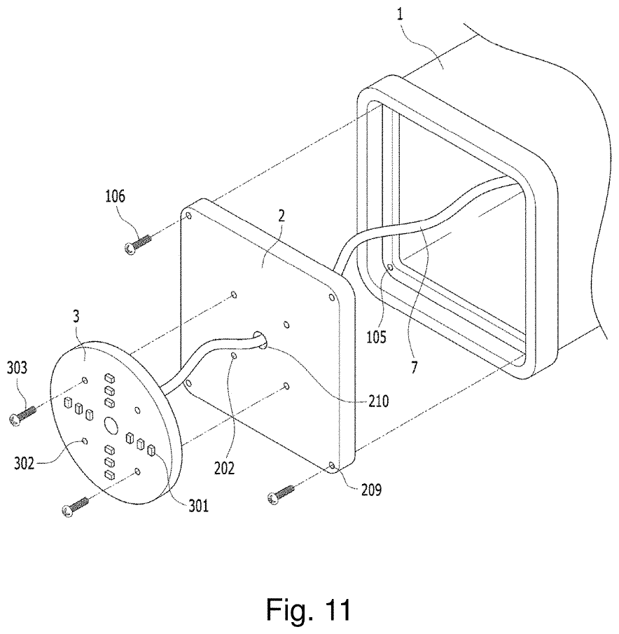

FIG. 11 is an exploded perspective view showing the LED lamp plate structure 200 including a screw hole 209 communicating with a screw hole 105 of the lamp housing 1, and a through hole 210 through which an electric wire 7 passes, according to the embodiment of the present invention.

The LED module 3 may include the electric wire 7 connecting with a power device and a controller needed to light the lamp. The heat dissipation plate 2 may include the through hole 210 through which the electric wire 7 of the LED module 3 passes. The through hole 210, a hole for passing the electric wire 7 therethrough, is not necessarily provided in the center of the heat dissipation plate 2. The position and size of the through hole 210 provided at the heat dissipation plate 2 are variable, and the through hole 210 may be located at the edge of the heat dissipation plate 2 to connect the electric wire 7 of the LED module 3 to the inside of the lamp housing 1.

FIG. 11 shows that the lamp housing 1 and the heat dissipation plate 2 are engaged by a screw 106 and the screw holes 105 and 209, not by the lock device 5 such as hook clamp, clamp, etc. Since the object of the present invention is replacing the existing street lamps, the lamp housing 1 may be an existing product. In order to communicate the screw hole 209 of the heat dissipation plate 2 with the existing screw hole 105 of the lamp housing 1, the specification and size of the lamp housing 1 need to be grasped in advance. Therefore, the position and size of the screw hole 209 of the heat dissipation plate 2 may be variable.

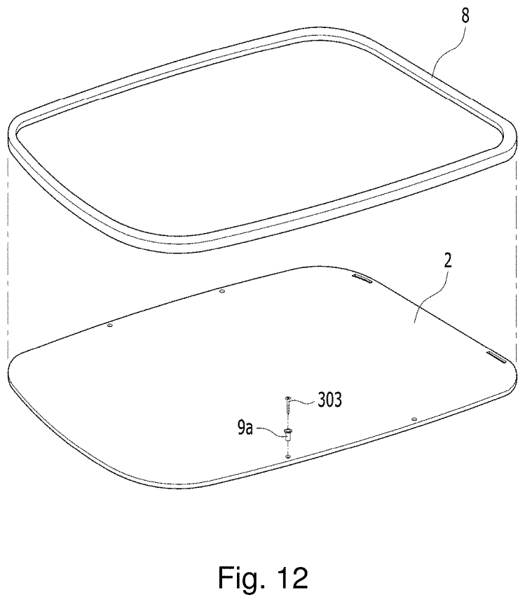

FIG. 12 is an exploded perspective view showing the heat dissipation plate 2 and a plate guard 8 according to the embodiment of the present invention.

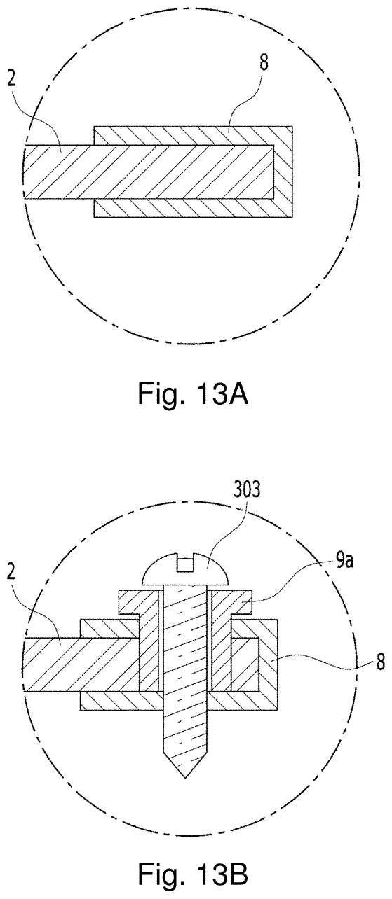

FIGS. 13A and 13B are sectional views showing the plate guard 8 and a screw guard 9a according to the embodiment of FIG. 12.

LED lamps have the advantage of lower power consumption and longer life span than conventional lamps. However, LED lamps are electronic components consuming current, so LED lamps are exothermic and attention should be paid to heat dissipation of the LED lamps.

As shown in FIG. 12, the LED lamp plate structure 200 according to the embodiment of the present invention may further include the plate guard 8.

The plate guard 8 may be made of an insulating material to prevent electrical and heat conduction. In addition, the plate guard 8 may be made of a material minimizing a volume and lightening a weight thereof. For example, the plate guard 8 may be made of at least one material selected from the group consisting of PE, XLPE, PVC, XL PVC, rubber (NR, EPDM CR, SI, CSM, SBR, IIR), PP, PET, PBT, and epoxy resin, but the scope of the present invention is not limited thereto.

The plate guard 8 may be configured to have an inner circumferential surface corresponding to the outer circumferential surface of the heat dissipation plate 2. In addition, the plate guard 8 may be configured to have an outer circumferential surface corresponding to the inner circumferential surface of lamp housing 1. The plate guard 8 with such inner and outer circumferential surfaces may be closely engaged with the heat dissipation plate 2. In addition, the plate guard 8 may be closely engaged with the lamp housing 1.

Thus, the plate guard 8 prevents heat and/or electricity of the lamp housing 1 from flowing into the LED module 3 and/or the heat dissipation plate 2, and supports and secures the coupling of the heat dissipation plate 2 and the lamp housing 1 more effectively. In addition, the likelihood of a power outage is reduced. Moreover, the plate guard 8 allows an easy separation of the heat dissipation plate 2 and the lamp housing 1.

It will be clear to those skilled in the art that the heat dissipation plate 2 and/or the plate guard 8 as described above may have various sizes and shapes depending on the lamp housing 1 installed.

For example, the heat dissipation plate 2 may be configured in a form of an open cup, at least in a part. An open portion of the heat dissipation plate 2 may be configured in a direction corresponding to the position of the transparent cover 4. Alternatively, a closed portion of the heat dissipation plate 2 may be configured in a direction corresponding to the position of the transparent cover 4, and the scope of the right of the present invention is not limited thereto.

According to the embodiment of the present invention, since the heat dissipation plate 2 is provided with the screw hole as described above, the heat dissipation plate 2 is engaged with the LED module by the screw 303. In addition, the heat dissipation plate 2 is firmly engaged with the lamp housing 1 as the screw 303 is tightened in the screw hole.

According to the embodiment of the present invention, the LED lamp plate structure further includes the screw guard 9a. The screw guard 9a is configured to correspond with the screw hole and the screw 303, which are provided to engage components of the LED lamp structure such as the heat dissipation plate 2.

In addition, the screw guard 9a may be configured as various shapes depending on an engaging order of the heat dissipation plate 2, the plate guard 8, and the screw guard 9a. This will be described below with reference to FIGS. 13 to 15.

The screw guard 9a may be configured with an insulating material to prevent electrical and heat conduction. In addition, the screw guard 9a may be configured with a material minimizing the volume and the weight thereof. For example, screw guard 9a may be formed of at least one material selected from the group consisting of PE, XLPE, PVC, XL PVC, rubber (NR, EPDM CR, SI, CSM, SBR, IIR), PP, PET, PBT, and epoxy resin, but the scope of the present invention is not limited thereto.

The screw guard 9a prevents heat and/or electricity from flowing through the screw 303 in the LED lamp plate structure.

It will be clear to those skilled in the art that the coupling by the screw hole and the screw 303 as described above is only an example according to the embodiment of the present invention, and various coupling means may be applied for coupling between any components included in the LED lamp plate structure.

Thus, an additional guard (not shown) for the coupling means applied in the coupling between any components included in the LED lamp plate structure should be included in the scope, while the screw guard 9a is shown and described in the present invention.

FIG. 13A shows that the plate guard 8 and the heat dissipation plate 2 are combined and FIG. 13B shows a position and a shape of the screw guard 9a, which is formed when the screw 303 is joined to the heat dissipation plate 2 combined with the plate guard 8.

Referring to FIG. 13B, since the heat dissipation plate 2 and the plate guard 8 are combined first, the screw 303 may be disposed at one region of the plate guard 8 when the screw hole of the heat dissipation plate 2 is joined with the screw 303. In such case, the screw guard 9a may be configured as a shape in which the screw 303 does not come into contact with one region of the plate guard 8 directly as shown in FIG. 13B.

The contents shown in FIGS. 13A and 13B are only examples according to an embodiment of the present invention, and the scope of rights of the present invention is not limited thereto. 14 and 15 will be referred to in this connection.

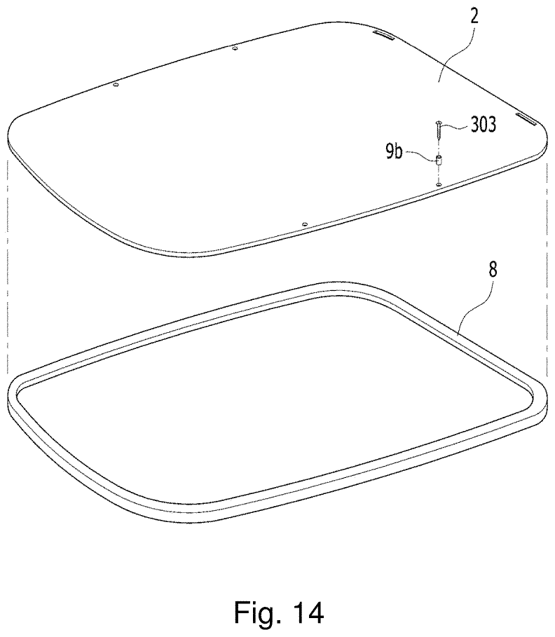

FIG. 14 is an exploded perspective view showing the heat dissipation plate 2 and the plate guard 8 according to another embodiment of the present invention.

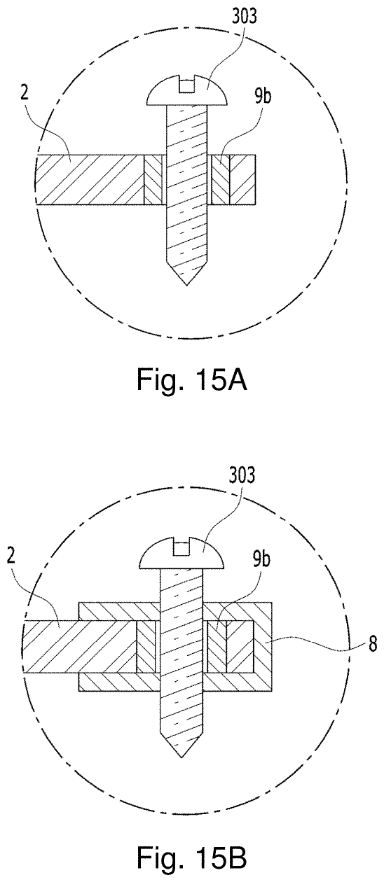

FIGS. 15A and 15B are sectional views showing the plate guard 8 and a screw guard 9b according to the embodiment of FIG. 14.

FIGS. 14, 15A, and 15B show that the screw 303 is joined to the heat dissipation plate 2 first. In such case, the screw guard 9b may be configured as a cylindrical shape as shown in FIG. 14.

FIG. 15A shows that the screw guard 9b and the screw 303 are joined to the screw hole of the heat dissipation plate 2, and FIG. 15B shows that the plate guard 8 is combined with the heat dissipation plate 2.

Although the preferred embodiments of the LED lamp plate structure according to the embodiment of the present invention have been disclosed for illustrative purposes, those skilled in the art will appreciate that various modifications, additions and substitutions are possible, without departing from the scope and spirit of the invention as disclosed in the accompanying claims. More specifically, the LED lamp plate structure having technical characteristics as described above, for example, may be applied to street light, tunnel light, security light, wall light, wire light, high bay, etc. More specifically, the LED lamp plate having technical characteristics as described above is combined with a bracket for street lights to provide a street light product. In addition, the LED lamp plate according to the embodiment of the present invention is combined with a bracket for tunnel lights to provide a tunnel light product. Meanwhile, the wall light is used to provide ambient lighting for all sorts of spaces, and an MPP wall light is a type of product that is attached directly to the wall or attached by an installation device. In addition, the wire light is a type of product that allows lights to be installed by connecting wires between buildings where pole-shaped street lights are impossible to be installed. The high bay is a product for a factory and high ceiling indoor that is installed by fixing a rear bracket directly to the ceiling or by connecting wires.

The description of the exemplary embodiments presented herein is provided in order to enable those of ordinary skill in the art to embody and practice the present invention. Various changes and modifications made to these exemplary embodiments will be apparent to those of ordinary skill in the art to which the present invention belongs, and the general principles defined herein will be applied to other exemplary embodiments without departing from the scope of the present invention. Accordingly, the present invention is not limited to the exemplary embodiments presented herein, but should be interpreted in a wide range consistent with the principles and novel characteristics provided herein.

What is claimed is:

1. A LED lamp plate structure, the structure comprising:
an LED module composed of at least one LED element; and
a heat dissipation plate having a surface area capable of allowing the heat dissipation plate to be engaged with at least a portion of a lamp housing of a street light, with the LED module being coupled on one surface of the heat dissipation plate so that the LED module faces an open surface of the lamp housing.

2. The LED lamp plate structure of claim 1, wherein the heat dissipation plate is provided with a plurality of depressions on at least one surface thereof to transfer heat easily.

3. The LED lamp plate structure of claim 2, wherein the depressions of the heat dissipation plate are treated to have an increased density dependent heat conductive characteristic, compared with an inside of the heat dissipation plate.

4. The LED lamp plate structure of claim 1, wherein the heat dissipation plate is provided on at least one surface thereof with at least one depression having a depressed cross section or at least one embossment having an embossed cross section, to enlarge a surface area.

5. The LED lamp plate structure of claims 1, wherein the heat dissipation plate is embossed on at least one surface thereof to have embossments to enlarge a surface area.

6. The LED lamp plate structure of claim 1, wherein each of the LED module and the heat dissipation plate is provided with at least one screw hole, in which the screw holes of the LED module and the heat dissipation plate communicate with each other to fasten the LED module and the heat dissipation plate together by using a screw.

7. The LED lamp plate structure of claim 1, further comprising:
a transparent cover combined with at least a portion of the heat dissipation plate to cover the LED module received in an inner space defined by the combination of the transparent cover and the heat dissipation plate.

8. The LED lamp plate structure of claim 1, wherein the LED module is provided with at least one screw hole at an outer peripheral portion thereof, and
the LED lamp plate structure further comprises:
a transparent cover provided with at least one screw hole communicating with the at least one screw hole of the LED module.

9. The LED lamp plate structure of claim 8, further comprising:
a rubber packing disposed between the LED module and the transparent cover and provided with at least one screw hole communicating with the at least one screw hole of each of the LED module and the transparent cover.

10. The LED lamp plate structure of claim 1, further comprising:
a lock device locking an edge of the heat dissipation plate to a protruding portion of the lamp housing of the street light, thereby coupling the heat dissipation plate to the lamp housing.

11. The LED lamp plate structure of claim 1, further comprising:
a heat dissipation plate-engaging means engaging the heat dissipation plate with the lamp housing,
wherein the heat dissipation plate-engaging means includes at least one vertical slide block and at least one lateral slide block provided on at least a portion of an upper surface of the heat dissipation plate,
wherein lower and upper surfaces of the at least one vertical slide block are configured as flat surfaces, and at least one side surface thereof is configured as an upward sloped surface sloped at a predetermined degree angle, and
lower and upper surface of the at least one lateral slide block are configured as flat surfaces, and at least one side surface thereof is configured as a downward sloped surface sloped at a predetermined degree angle to be brought into close contact with the upward sloped surface.

12. The LED lamp plate structure of claim 11, wherein the vertical slide block further includes: a through hole that penetrates therethrough vertically; and an adjustment screw that is inserted into the through hole, the adjustment screw being provided with an annular groove on which a snap ring is mounted in order to fix the vertical slide block on the heat dissipation plate, and
the lateral slide block further includes: an elongated hole that penetrates therethrough vertically and provides an area enabling the lateral slide block to move rectilinearly;
and a guide bolt that is inserted into the elongated hole and couples the lateral slide block with the heat dissipation plate, with a fixing nut being fastened to the guide bolt after the guide bolt penetrates the elongated hole and the heat dissipation plate, thereby fixing the guide bolt.

13. The LED lamp plate structure of claim 11, wherein two side surfaces of the vertical slide block are configured as upward sloped surfaces, and
the lateral slide block is configured such that a pair of lateral slide blocks comes into close contact with one vertical slide block so that the downward sloped surfaces of the lateral slide blocks come into contact with the upward sloped surfaces of the vertical slide block, respectively.

14. The LED lamp plate structure of claim 11, wherein, when the vertical slide block rises, the lateral slide block is pressed against an inner side surface of the lamp housing such that a normal force between the lamp housing and the lateral slide block is increased.

15. The LED lamp plate structure of claim 1, wherein the heat dissipation plate is provided with a screw hole communicating with a screw hole of the lamp housing so that the heat dissipation plate is coupled with the lamp housing of the street light.

16. The LED lamp plate structure of claim 1, wherein the heat dissipation plate is provided with a through hole through which an electric wire extending from the LED module passes.

17. The LED lamp plate structure of claim 1, further comprising:
a plate guard made of an insulating material and configured to have an inner circumferential surface corresponding to an outer circumferential surface of the heat dissipation plate.

18. The LED lamp plate structure of claim 1, wherein the heat dissipation plate includes at least one of at least one depression and at least one perforation on at least one portion of a cross section thereof.
